(19) United States
(12) Patent Application Publication
(10) Pub. No.: US 2021/0080851 A1
(43) Pub. Date: Mar. 18, 2021

(54) IMAGE FORMING APPARATUS

(71) Applicant: CANON KABUSHIKI KAISHA, Tokyo (JP)

(72) Inventor: Naoki Fukushima, Mishima-shi (JP)

(21) Appl. No.: 17/016,759

(22) Filed: Sep. 10, 2020

(30) Foreign Application Priority Data
Sep. 12, 2019 (JP) 2019-166195

(51) Int. Cl. G03G 15/02

(52) U.S. Cl. CPC G03G 15/0275

(57) ABSTRACT

An image forming apparatus, including: a potential detection portion that detects information relating to a surface potential formed on a surface of an image bearing member; and a control portion that calculates a first charging voltage, at which the surface potential has a first value, on the basis of the information, and that controls the potential detection portion, wherein the potential detection portion acquires a plurality of the information items under a plurality of conditions where charging voltage differs, and wherein the control portion calculates the first charging voltage from a deviation of the charging voltage, which is a deviation deriving from an apparatus main body and calculated on the basis of the plurality of the information items and the first value, and controls a power supply portion so that the first charging voltage is applied to a charging member during an image forming operation.

### BACKGROUND OF THE INVENTION

### Field of the Invention

The present invention relates to an image forming apparatus.

### Description of the Related Art

Image forming apparatuses known in the prior art include, for instance, copying machines relying on electrophotographic systems or electrostatic recording systems, laser beam printers, facsimile machines and the like. Using a process cartridge in such image forming apparatuses for the purpose of facilitating maintenance is a known feature. The process cartridge is herein a member, in which a photosensitive drum, a charging roller, a cleaning member, a developing sleeve, a toner container and so forth are integrated together, and which is configured to be attachable/detachable to/from the image forming apparatus.

During image formation using the process cartridge, the surface of the photosensitive drum is uniformly charged by discharge of the charging roller. The potential at this time is referred to as dark area potential V_{D}. Subsequently, an exposure device irradiates the surface of the photosensitive drum with light, to thereby form an electrostatic latent image. The potential of the image formation portion in this case is referred to as light area potential V_{L}. A developing sleeve supplies toner to the photosensitive drum, as a result of which the electrostatic latent image formed on the surface of the photosensitive drum becomes visible as a toner image.

Next, a transfer device transfers the toner image to a recording material, and a recorded image is formed through fixing of the image on the recording material by a fixing apparatus. Meanwhile, on the process cartridge side after separation of the recording material, a cleaning member scrapes off untransferred toner from the surface of the photosensitive drum, to furnish the toner to a next image formation.

The image density in the electrophotographic image forming apparatus is correlated with developing contrast V_{cont}. The developing contrast V_{cont} is a potential difference between the light area potential V_{L} and a developing voltage V_{dc} of the photosensitive drum. Further, image fogging, in which toner adheres to a non-exposed portion and fouls a white background, is correlated with developing back contrast V_{back}. The developing back contrast V_{back} is a potential difference between the dark area potential V_{D} and the developing voltage V_{dc} of the photosensitive drum. In order to obtain a proper image, therefore, it is necessary to adequately control V_{cont} and V_{back}, using a surface potential, such as the dark area potential V_{D} or light area potential V_{L}, as a reference potential.

In the prior art, methods are known that involve estimating the surface potential of the photosensitive drum, for instance, on the basis of the usage state of the photosensitive drum, and controlling thereupon V_{cont} and V_{back}. However, the dark area potential V_{D} may, in some instances, deviate from a targeted value on account of factors on the apparatus main body side and on the process cartridge side. Examples of such causes include variations in the discharge start voltage due to the influence of atmospheric pressure, and variations in output values due to the high-voltage circuit tolerance of the image forming apparatus main body.

Therefore, Japanese Patent Application Publication No. 2012-013881 proposes actually detecting the surface potential of the photosensitive drum, and correcting the surface potential with high precision. In Japanese Patent Application Publication No. 2012-013881, specifically, DC voltage of positive polarity and negative polarity are applied to a charging roller. The DC voltage (discharge start voltage) applied to the charging roller at a time of starting respective discharge of positive polarity and negative polarity in the photosensitive drum is determined, and then the surface potential of the photosensitive drum is calculated on the basis of each discharge start voltage that has been determined.

The respective discharge characteristics of the photosensitive drum for positive polarity and negative polarity may differ from each other. In Japanese Patent Application Publication No. 2018-005036, therefore, a reference potential in a state of stabilized surface potential on the drum surface is created by an exposure means, and the surface potential of the photosensitive drum is calculated using a difference between the reference potential and a surface potential detection result in the absence of exposure.

### SUMMARY OF THE INVENTION

However, the surface potential of the photosensitive drum fluctuates under the influence of variability in a high-voltage power source of the image forming apparatus main body and variability in the process cartridge. Accordingly, the surface potential needs to be detected again when the process cartridge is replaced.

The surface potential of the photosensitive drum during exposure may be not stable, depending on the usage situation of the process cartridge inserted in the main body, and detection accuracy may be low.

The present invention has been made in light of the above considerations and an object thereof is to provide a technique for precisely correcting the surface potential of a photosensitive drum, even upon replacement of a process cartridge in an image forming apparatus.

An image forming apparatus according to the present invention, including:

an apparatus main body; and

a process cartridge that is replaceable relative to the apparatus main body,

the process cartridge having:

an image bearing member; and

a charging member that forms, by being applied with charging voltage, a surface potential by charging a surface of the image bearing member,

the apparatus main body having:

a power supply portion that applies the charging voltage to the charging member;

a potential detection portion that detects surface potential information relating to the surface potential formed on the surface of the image bearing member; and

a control portion that calculates a first charging voltage, at which the surface potential has a first value, on the basis of the surface potential information, and that controls the power supply portion and the potential detection portion,

wherein the potential detection portion acquires a plurality of the surface potential information items under a plurality of conditions where the charging voltage differs, and

wherein the control portion calculates the first charging voltage from a deviation of the charging voltage, which is a deviation deriving from the apparatus main body and calculated on the basis of the plurality of the surface potential information items and the first value, and controls the power supply portion so that the first charging voltage is applied to the charging member during an image forming operation.

The present invention succeeds in providing a technique for precisely correcting the surface potential of a photosensitive drum, even upon replacement of a process cartridge in an image forming apparatus.

Further features of the present invention will become apparent from the following description of exemplary embodiments with reference to the attached drawings.

### BRIEF DESCRIPTION OF THE DRAWINGS

FIG. 1 is a flowchart of a charging voltage determination sequence of Embodiment 1;

FIG. 2 is a cross-sectional diagram illustrating schematically a process cartridge of Embodiment 1;

FIG. 3 is a cross-sectional diagram illustrating schematically an image forming apparatus of Embodiment 1;

FIG. 4 is a control block diagram of the image forming apparatus of Embodiment 1;

FIG. 5 is a circuit diagram of a configuration for detection of surface potential of a photosensitive drum;

FIG. 6 is a diagram for explaining a relationship between a transfer voltage value and a transfer current value; and

FIG. 7 is a flowchart of a charging voltage determination sequence of Embodiment 2.

### DESCRIPTION OF THE EMBODIMENTS

Preferred embodiments of the present invention will be explained in detail below by way of illustrative examples, with reference to accompanying drawings. Unless noted otherwise, however, the scope of the present invention is not meant to be limited to only the dimensions, materials, shapes, relative arrangements and so forth of the constituent components disclosed in the embodiments. Further, the materials, shapes and so forth of members having been described once in the following explanation below are, unless otherwise indicated anew, identical to those in the initial explanation.

### Embodiment 1

### Explanation of an Image Forming Apparatus

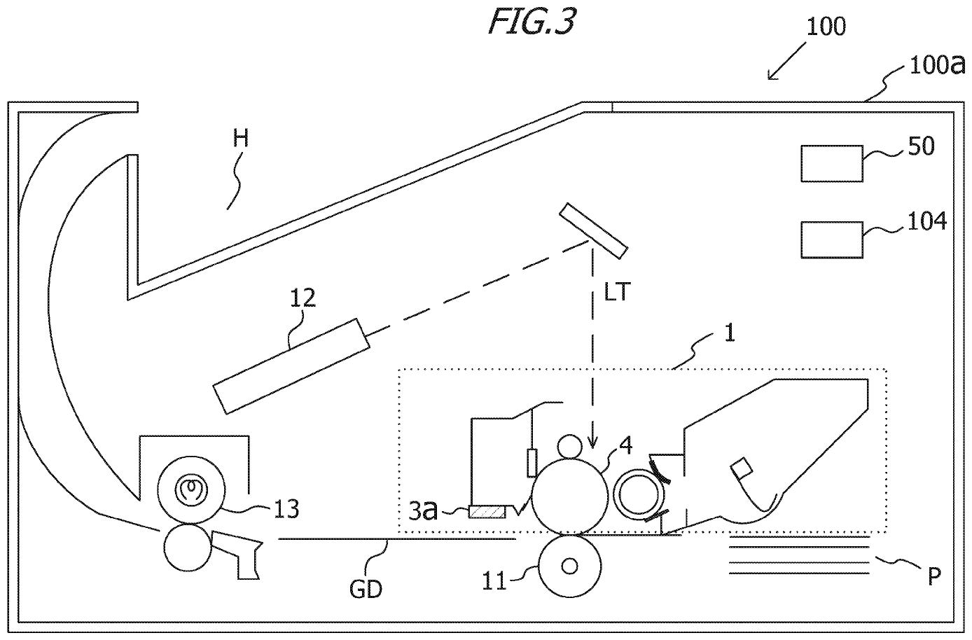

The overall structure of an electrophotographic image forming apparatus 100 will be explained with reference to the schematic cross-sectional diagram of FIG. 3. The image forming apparatus 100 has an image forming apparatus main body 100a and a process cartridge 1. The image forming apparatus 100 of FIG. 3 is in a state having the process cartridge 1 attached thereto. Schematically, the image forming apparatus main body 100a is provided with an exposure device 12, a transfer roller 11, a fixing apparatus 13, a control unit 50 and a high-voltage power source 104. The process cartridge 1 is replaceable relative to the image forming apparatus main body 100a, for the purpose of replacement or maintenance.

An outline of an image forming operation will be explained next. A control unit 50 (control portion) acquires image information of an image to be formed, through external reception or through reading from a memory. The control unit 50 controls the exposure device 12 so as to irradiate the surface of a photosensitive drum 4 of the process cartridge 1 with information light LT based on image information. An electrostatic latent image becomes formed as a result on the surface of the photosensitive drum 4 that is charged by a charging roller 5. The electrostatic latent image is developed with a developer (toner T) accommodated in a toner storage chamber 14 of the process cartridge 1, so that a toner image becomes formed as a result.

In synchrony with formation of the toner image, a recording material P stored in a cassette is separated and fed, sheet by sheet, by a pick-up roller and a pressing member. For instance, recording paper, OHP sheets, cloth and the like can be used as the recording material P. The recording material P thus fed moves along a conveyance guide GD to a transfer portion at which the photosensitive drum 4 and the transfer roller 11 oppose each other. At the transfer portion, the transfer roller 11 transfers the toner image on the photosensitive drum 4 onto the recording material P.

When using an image forming apparatus in which a color image is formed using a plurality of colors, there may be used a plurality of respective process cartridges 1 corresponding to each color. In that case, the toner images on the photosensitive drums 4 of the respective colors may be first transferred to an intermediate transfer member, such as a transfer belt, after which the color image is formed on the recording material P.

The recording material P is then conveyed to the fixing apparatus 13 along the conveyance guide GD. The fixing apparatus 13 has a driver roller and a fixing rotating member made up of a tubular sheet rotatably supported by a support and having a heater built therein, and fixes the transferred toner image by applying heat and pressure to the passing recording material P. A discharge roller (not shown) conveys next the recording material P, and discharges the recording material P to a discharge section H via a reversal conveying path.

Explanation of a Process Cartridge

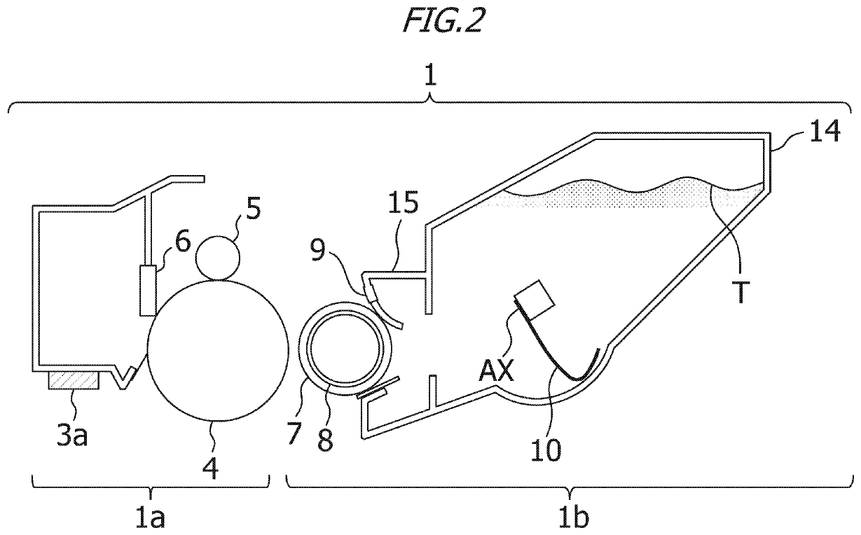

The configuration of the process cartridge 1 will be explained next with reference to the schematic cross-sectional diagram of FIG. 2.

The process cartridge 1 is provided with a drum frame 1a (drum unit) and a developing unit 1b. The drum frame 1a rotatably supports the photosensitive drum 4 (image bearing member). A charging roller 5 (charging member), a cleaning blade 6 and a CRG memory 3a are provided in the drum frame 1a. The developing unit 1b is made up of a developing chamber 15 and the toner storage chamber 14. A developing sleeve 7, a magnet roller 8 and a regulating blade 9 are disposed in the developing chamber 15. The toner storage chamber 14 accommodates toner T. The toner storage chamber 14 is provided with a stirring member 10.

The process cartridge 1 is attachable/detachable to/from the image forming apparatus main body. The drum unit portion and the developing unit portion may be individually attachable/detachable to/from the main body, and the drum unit portion and the developing unit portion may be integrated with each other. The developing chamber portion and the toner storage chamber portion of the developing unit may be attachable/detachable individually.

The process cartridge 1 rotationally drives the photosensitive drum 4 having a photosensitive layer. In the present embodiment, the diameter of the photosensitive drum 4 is 124 mm, and the speed of rotary driving is set to 370 mm/sec. The charging roller 5, which is a conductive elastic roller, has a core metal, and a conductive elastic layer that covers the core metal. The diameter of the core metal of the charging roller 5 is Φ6 mm, and the diameter of the conductive elastic layer portion is Φ12 mm. The charging roller 5 is pressed against the photosensitive drum 4 with a predetermined pressing force.

Herein the CRG memory 3a (cartridge memory) is attached to the process cartridge 1. For instance, a non-volatile memory disposed in the process cartridge (CRG) may be used as the CRG memory 3a. Various information items pertaining to image forming control are stored in the CRG memory 3a. In the present embodiment, in particular, there is stored information for correcting fluctuation factors deriving from the process cartridge side, in an estimation of surface potential.

Image Forming Operation in the Process Cartridge

The image forming apparatus 100 has a high-voltage power source 104 (power supply unit). The high-voltage power source 104 applies charging voltage to a core metal of the charging roller 5. When a potential difference between the surface potential of the photosensitive drum 4 and the potential of the charging roller 5 becomes equal to or greater than a discharge start voltage, discharge is initiated through application of charging voltage to the core metal of the charging roller 5. As a result, the surface of the photosensitive drum 4 is charged uniformly, and a dark area potential (V_{D}) becomes formed thereby on the surface of the photosensitive drum 4. In the present embodiment, a standard charging voltage Vₚᵣₑ at the time of charging voltage application is set to −1050 V. A target value (V_{DTarget}) (first value) of the dark area potential V_{D} in this case is set to −500 V.

The exposure device 12 irradiates then the photosensitive drum 4 with the information light LT based on the image information about the image to be formed, via an exposure aperture. As a result, a light area potential (V_{L}) is formed through disappearance of charge on account of carriers from a carrier generating layer on the surface of the photosensitive drum 4. The light area potential at this time is set to −100 V. An electrostatic latent image is formed thereby on the photosensitive drum 4, by the dark area potential V_{D} and the light area potential V_{L}.

As described in detail further on, the light area potential V_{L} formed by irradiation with the information light LT converges to a value close to 0, and therefore is comparatively stable. By contrast, the dark area potential V_{D} formed by application of charging voltage is comparatively prone to deviate from a target value on account of significant variation arising from the state of the high-voltage power source, and due to individual differences among process cartridges.

The electrostatic latent image is subsequently developed by the toner T in the interior of the toner storage chamber 14, and a visible image is formed as a result.

Negative magnetic toner, being an insulating one-component magnetic developer, is used as the toner T in the present embodiment. The volume-average particle diameter of the toner T is about 8.0 μm. The toner T is accommodated in an amount of 400 g in the toner storage chamber 14.

The stirring member 10 is disposed in the interior of the toner storage chamber 14. The stirring member 10 of the present embodiment is formed by fixing a sheet of polyethylene terephthalate material on a mounting axis AX. Specifically, a fitting hole of the sheet is fitted into a dowel provided on the mounting axis AX, and the tip of the dowel is expanded by heat welding, to thereby fix the sheet on the mounting axis AX. The stirring member 10 thus formed is disposed on the frame of the toner storage chamber 14, and is caused to rotate by the drive unit, as a result of which toner T inside the toner storage chamber 14 becomes conveyed to the developing chamber.

A developing sleeve 7 that is rotationally disposed is provided in the developing chamber 15. The developing sleeve 7 in Embodiment 1 results from coating the surface of a non-magnetic aluminum sleeve with a resin layer that contains conductive particles. The surface of the developing sleeve 7 is set to have an arithmetic average roughness Ra of 1.0 μm. The diameter of the sleeve is Φ16.0 mm. At the time of image formation, the toner T can be conveyed to an opposing portion of the photosensitive drum 4 and the developing sleeve 7, through rotation of the developing sleeve 7 at 350 mm/sec. The developing sleeve 7, which has a hollow shape, encloses a non-rotating magnet roller 8 having a magnetic field generating portion of multi-pole structure. The diameter of the magnet roller is Φ14 mm. The magnet roller 8 draws the toner T to the developing sleeve 7 through the action of magnetic forces.

A regulating blade 9 is fixed in the vicinity of the developing sleeve 7. The regulating blade 9 comes elastically in contact with the developing sleeve 7, at a predetermined pressure. The thickness of the layer of toner T supported on the developing sleeve 7 is regulated as a result to a constant thickness. Simultaneously therewith, the toner T becomes charged on account of triboelectric charging. In Embodiment 1, the regulating blade 9 is formed out of a silicone rubber having a rubber hardness JISA of 40°. The regulating blade 9 is disposed so that a contact pressure Pr (Pr: contact weight (gf) per unit length (1 cm) in the longitudinal direction of the developing sleeve) of the regulating blade 9 against the developing sleeve 7 is about 25 g/cm.

In the present embodiment a gap holding member, not shown, is disposed between the developing sleeve 7 and the photosensitive drum 4, so that a gap is formed as a result therebetween. The gap is set to 300 μm. A developing power source is connected to the developing sleeve 7. Through application of voltage from the developing power source to the developing sleeve 7, a predetermined electric field forms between the photosensitive drum 4 and the developing sleeve 7. As a result, the electrostatic latent image on the surface of the photosensitive drum 4 is reversely developed by the toner T, to become visible.

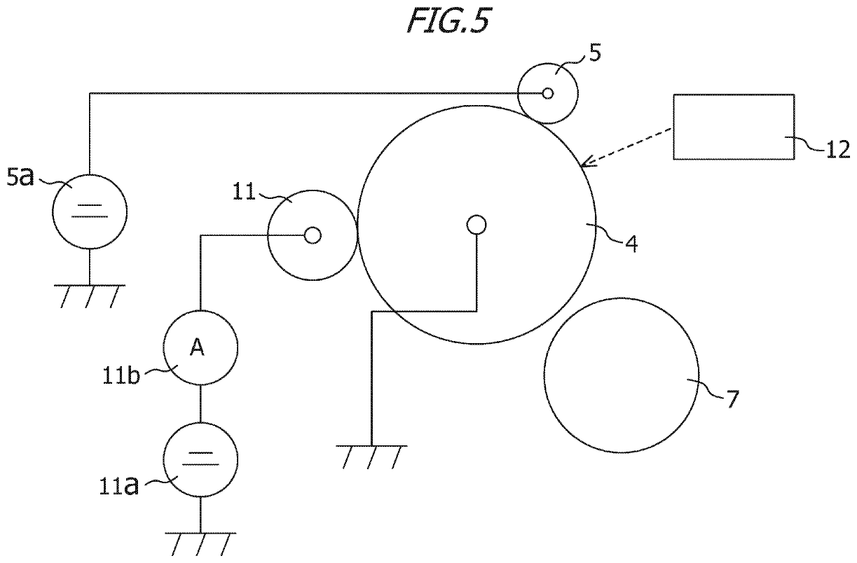

In Embodiment 1 the developing power source applies voltage having a square waveform, with DC voltage of −350 V, AC voltage of 1200 Vpp and frequency of 1500 Hz, to the developing sleeve 7. The toner T can fly through the gap between the photosensitive drum 4 and the developing sleeve 7, as a result of application of the above voltage to the developing sleeve 7. Image formation is carried out thereby, through developing by electrical adhesion of the negatively charged toner T onto the latent image portion on the photosensitive drum 4. The present disclosure can however be applied to non-contact developing system and to contact developing system. The high-voltage power source 104 may be a developing power source, or alternatively a developing power source may be disposed separately from the high-voltage power source 104. In FIG. 5 described below, a charging voltage application circuit 5a and a transfer voltage application circuit 11a are depicted as separate structures, but the high-voltage power source 104 may double as the charging voltage application circuit 5a and the transfer voltage application circuit 11a.

Operation of the Apparatus Body

Subsequently, the high-voltage power source 104 applies voltage of reverse polarity to that of the toner image, to the transfer roller 11, as a result of which the toner image on the photosensitive drum 4 is transferred onto the recording material P. The recording material P is conveyed via the conveyance guide GD. Meanwhile, the toner T remaining on the photosensitive drum 4 in the process cartridge 1 is removed by the cleaning blade 6 fixed to the drum frame 1a. Thereafter, the surface of the photosensitive drum 4 is charged again by the charging roller 5, and the above steps are repeated.

Block Diagram

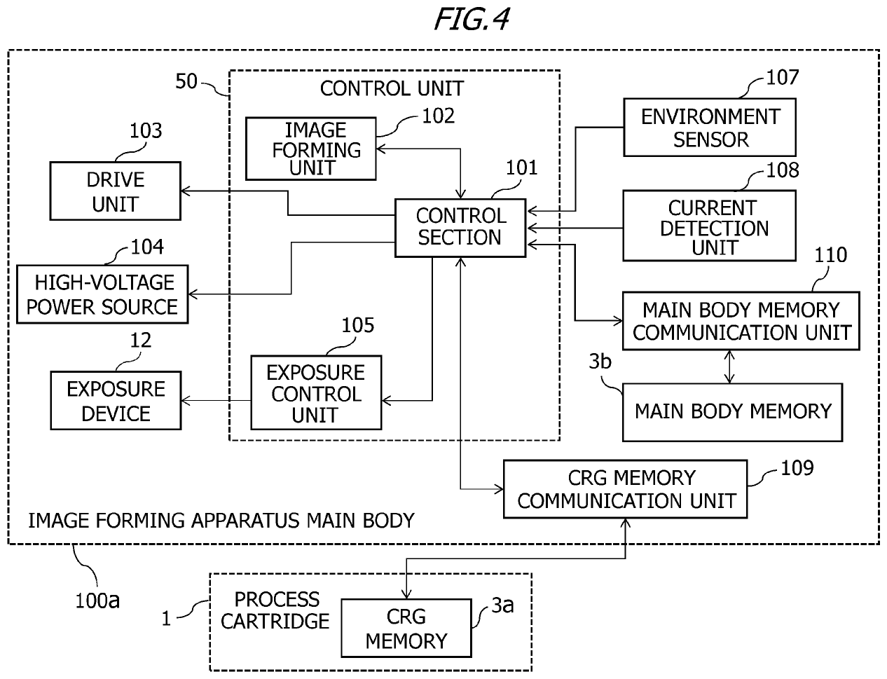

A control block diagram of the image forming apparatus 100 will be explained next with reference to FIG. 4. The control unit 50 disposed in the image forming apparatus main body 100a is a control portion that controls various instances of information processing, and the various constituent elements of the apparatus, that are necessary for image formation. For instance, an information processing device having a computing resource such as a CPU, a memory and an interface (input/output I/F) for inputting/outputting information to/from peripheral devices, can be used herein as the control unit 50. Each functional block included in the control unit 50 may be embodied in physical form, or may be realized as a program module or the like. In the present embodiment, the control section 101, the image forming unit 102 and the exposure control unit 105 are described as functional blocks included in the control unit 50, but the division of functional blocks is not limited thereto.

In Embodiment 1, a storage unit such as a ROM or RAM is used as the main body memory 3b (main-body-side memory). The RAM stores for instance detection results by sensors and computation results by the CPU. The ROM stores for instance a control program, and data tables established beforehand. A memory provided in the information processing device that makes up the control unit 50 may be used herein as the main body memory 3b. The control unit 50 communicates with the main body memory 3b via a main body memory communication unit 110. The control unit 50 also communicates with the CRG memory 3a via a CRG memory communication unit 109. Each memory communication unit is made up of for instance a memory reader, communication wiring and so forth.

The control section 101 in the control unit 50 is a block that controls integrally the entire image forming apparatus 100. The control section 101 executes various controls set out in a below-described flowchart, according to a program or to a user operation. The image forming unit 102 generates an image pattern, and determines an image writing position, on the basis the image data to be formed. The exposure control unit 105 determines the quantity and timing of laser light with which the photosensitive drum 4 is irradiated, on the basis of the image pattern generated by the image forming unit 102, and transmits a control signal to the exposure device 12.

The drive unit 103 provided as a constituent element of the image forming apparatus main body 100a is a power source for driving the units of the image forming apparatus 100. The drive unit 103 includes for instance a motor for rotationally driving a polygon scanner, the photosensitive drum 4, the developing sleeve 7 and so forth. The drive unit 103 operates on the basis of a control signal from the control section 101.

The high-voltage power source 104 is a power source that applies high voltage to various constituent elements, such as the photosensitive drum 4, the charging roller 5, the developing sleeve 7, the transfer roller 11 and the fixing apparatus 13. However, respective power source devices may be provided divisionally for each constituent element. The voltage applied to the transfer roller 11 will be referred to hereafter as transfer voltage.

An environment sensor 107 (environment information acquisition unit) is a sensor, provided in the image forming apparatus 100, for measuring environment information. Temperature and humidity are measured herein as environment information. The environment sensor 107 transmits measured temperature and humidity to the control section 101.

The current detection unit 108 detects current corresponding to the surface potential of the photosensitive drum 4, and transmits surface potential information acquired on the basis of the detected current value, to the control section 101. The current detection unit 108 detects thus surface potential information relating to the surface potential of the photosensitive drum 4. The current detection unit 108 corresponds to the below-described transfer current detection circuit 11b, and can be configured out of an existing current detection circuit. In FIG. 4, the current detection unit 108 is depicted as built into the apparatus main body, but the current detection unit 108 may be disposed in the process cartridge 1. The current detection unit 108 corresponds to the potential detection unit of the present invention. Alternatively, a combination of the current detection unit 108 which is a sensor and the control unit 50 that calculates surface potential on the basis of a sensor output, may be regarded as the potential detection unit.

Detection of the Surface Potential of the Photosensitive Drum

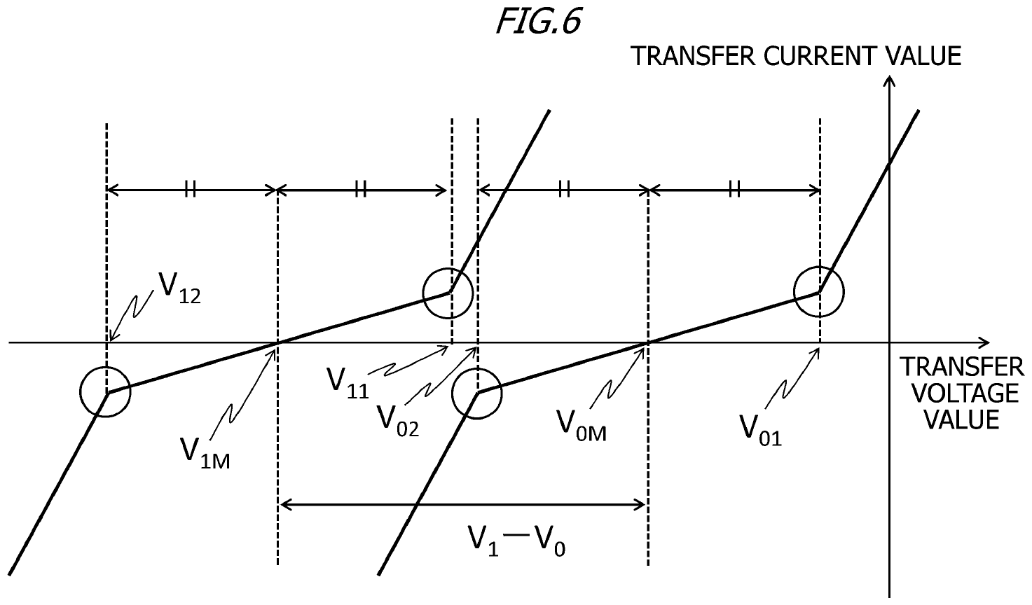

An explanation follows next on the method in which the current detection unit 108 measures the surface potential of the photosensitive drum 4 via the transfer roller 11. FIG. 5 is a circuit diagram illustrating schematically ancillary structures of the photosensitive drum 4 and the transfer roller 11, and which pertain to potential detection. FIG. 6 is a diagram for explaining a relationship between a transfer voltage value and a transfer current value.

The control section 101 acquires a transfer voltage value that the high-voltage power source 104 is to apply to the transfer roller 11. For instance, the control section 101 can acquire the transfer voltage value by referring to a control value at a time when the control section 101 controls the high-voltage power source 104. Further, the control section 101 acquires a value (hereafter referred to as transfer current value) of the current flowing in the photosensitive drum 4, and detected by the transfer current detection circuit 11b as a current detection unit 108, via the transfer roller 11. The surface potential of the photosensitive drum 4 is detected through comparison between the transfer voltage value and the transfer current value. In the explanation below, the control section 101 detects the value of the dark area potential V_{D}, in the surface potential of the photosensitive drum 4. However, the present invention is not limited thereto, and an arbitrary surface potential, for instance the light area potential V_{L}, may be detected.

A method for calculating the dark area potential V_{D} of the photosensitive drum 4 will be explained next with reference to FIG. 6. FIG. 6 illustrates a relationship between a transfer voltage value (horizontal axis) and a transfer current value (vertical axis). The transfer current value obeys Paschen's law with respect to the dark area potential V_{D} of the photosensitive drum 4, so that discharge starts at a certain transfer voltage value, as a boundary. This transfer voltage value constitutes a discharge start voltage. As described below, the light area potential V_{L} is treated as a reference potential in Embodiment 1. In the explanation that follows, therefore, the light area potential V_{L} will be marked with the prefix “V₀”. The dark area potential V_{D} to be calculated will in turn be prefixed with “V₁”, to be distinguished from the foregoing. The following discharge start voltage values are defined herein.

V₀₁: positive discharge start voltage (bright area positive discharge start voltage) relative to the light area potential V₀

V₀₂: negative discharge start voltage (bright area negative discharge start voltage) relative to the light area potential V₀

V₁₁: positive discharge start voltage (dark area positive discharge start voltage) relative to the dark area potential V₁

V₁₂: negative discharge start voltage (dark area negative discharge start voltage) relative to the dark area potential V₁

The respective values of each discharge start voltage depend for instance on the value of surface potential (dark area potential V₁ and light area potential V₀), the distance between the photosensitive drum 4 and the transfer roller 11, atmospheric pressure, temperature, humidity, thickness of the photosensitive drum 4 and so forth.

The positive discharge start voltage and the negative discharge start voltage do not exhibit a perfectly symmetrical relationship. In Embodiment 1, therefore, it is necessary to measure first the light area potential V₀, which is the reference potential, and measure subsequently the dark area potential, on the basis of a difference between the discharge start voltage of the light area potential V₀ and the discharge start voltage of the dark area potential V₁.

As denoted by the circle symbols in FIG. 6, the transfer current value changes sharply at the discharge start voltage. Therefore, the control section 101 controls the high-voltage power source 104 so as to modify the applied voltage little by little, and determines that discharge has started when the value detected by the current detection unit 108 changes abruptly.

As described above, the light area potential V₀ is comparatively stable regardless of the charging voltage and the film thickness of the photosensitive drum 4. In Embodiment 1, therefore, an ideal value (V_{0ID}) of the light area potential V₀ is stored beforehand in the CRG memory 3a or in the main body memory 3b. Preferably, a convergent value of V₀ is worked out beforehand through experimentation, to yield the ideal value V_{0ID}.

The potential difference between a midpoint (V_{1M}) of V₁₁ and V₁₂, which is the detection result, and a midpoint (V_{0M}) of V₀₁ and V₀₂ is equal to the potential difference between the dark area potential V₁ and the light area potential V₀. Accordingly, the dark area potential V₁ of the photosensitive drum 4, the discharge start voltages V₁₁, V₁₂, V₀₁, V₀₂, and the ideal value V_{0ID} of the light area potential V₀ obey the relationship of Expression (1). The control section 101 calculates thus the dark area potential V₁ of the photosensitive drum 4 by plugging the discharge start voltages, which are detection results, in Expression (1).

V₁=(V₁₁+V₁₂)/2−(V₀₁+V₀₂)/2+V_{0ID} Expression (1)

In the present embodiment, the dark area potential V_{D} is calculated using both positive and negative electrode discharge start voltages, in order to improve precision. However, the dark area potential V₁ can be acquired by using either a positive or a negative discharge start voltage alone. Expression (11) corresponds to a case where positive transfer is used, and Expression (12) to a case where negative transfer is used.

V₁=V₁₁−V₀₁+V_{0ID} Expression (11)

V₁=V₁₂−V₀₂+V_{0ID} Expression (12)

The control section 101 may perform control so as to acquire a transfer current value a plurality of times, while modifying the transfer voltage value, by means of the current detection unit 108, to thereby acquire a plurality of discharge start voltages at which discharge is initiated, between the charging roller 5 and the photosensitive drum 4, and so as to acquire surface potential information, on the basis of the plurality of discharge start voltages.

In Embodiment 1 the value of transfer current flowing upon application of transfer voltage is detected, to thereby calculate the dark area potential V₁ of the photosensitive drum 4. However, the present invention is not limited thereto. It suffices to know a relationship between voltage and current, and hence the dark area potential V₁ may be calculated for instance through detection of voltage of an instance where a constant current is applied.

Calculation of the Slope of Charging Voltage and a Divergence Amount Other than that of Charging Voltage)

The surface potential of the photosensitive drum 4 in Embodiment 1 varies depending on for instance the charging voltage of the high-voltage power source 104 of the image forming apparatus main body 100a, the film thickness of the photosensitive drum 4, humidity, atmospheric pressure and so forth. In cases of variation of film thickness of the photosensitive drum 4, the temperature, the humidity or atmospheric pressure, then the discharge start voltage as well varies with the foregoing. Accordingly, a difference with respect to an ideal value is constant, even when the absolute value of the charging voltage varies with changes in film thickness and so forth. The slope of the ideal value and output values vary for instance depending on circuit resistance constants. For instance, the charging voltage value aimed at by control and the actually applied charging voltage value may deviate from each other. Therefore, such a variation in charging voltage must be calculated to be used for correction.

In a conventional example, factors of variation of the surface potential of the photosensitive drum 4 are not known, and accordingly it is necessary to detect the surface potential once again upon replacement of a cartridge unit. In a case where the replacing cartridge is not new, however, the surface potential of the photosensitive drum 4 is not sable, and the precision of the detection result is impaired in some instances.

In Embodiment 1, a measurement is performed by setting two conditions in order to calculate a charging voltage variation amount. Under the first condition, each discharge start voltage is worked out by setting the charging voltage to −1050 V (charging voltage EV1) in the same way as above. A first dark area potential V_{1(A)} is calculated (first detection result) on the basis of Expression (1). Under the second condition, the discharge start voltages are worked out by modifying the charging voltage to −850 V (charging voltage EV2), after which the second dark area potential V_{1(B)} is calculated (second detection result) on the basis of Expression (1).

Next, a slope α of the charging voltage and a cartridge-derived variation amount β, which is the variation amount of the discharge start voltage across the photosensitive drum 4 and the charging roller 5, are calculated using the detection results under the two conditions. The charging voltage slope a (information relating to the change of charging voltage) is an example of main body correction information corresponding to apparatus main-body-side factors, in the difference between a target value and an actually measured value of surface potential. The cartridge-derived variation amount β is an example of cartridge correction information corresponding to process cartridge-side factors, in the above difference between a target value and an actually measured value.

The control section 101 calculates the charging voltage slope α on the basis of Expression (2). The charging voltage slope α is information relating to variations on the high-voltage power source 104 side of the image forming apparatus main body 100a. The control section 101 stores, in the main body memory 3b, the charging voltage slope α calculated on the basis of Expression (2).

α=(V_{1(A)}−V_{1(B)})/(−1050+850) Expression (2)

Next, the control section 101 calculates the cartridge-derived variation amount β on the basis of Expression (3). Herein V_{DTarget} denotes a reference value (target value) of V_{D}.

β=(V_{1(A)}−V_{DTarget})−(α−1)=Vₚᵣₑ Expression (3)

The first term on the right side of the equation (3) is a mixture of variation due to cartridge-side factors and variation due to factors in the high-voltage power source 104 of the image forming apparatus main body 100a. The second term on the right side denotes variation due to factors in the high-voltage power source 104. Therefore, Expression (3) separates a variation amount β denoting variation by cartridge-side factors.

The control section 101 stores the calculated cartridge-derived variation amount β in the CRG memory 3a. In this case, preferably, environment information at the time of detection of the surface potential of the photosensitive drum 4 is stored together with the cartridge-derived variation amount β.

In Embodiment 1 the charging voltage under the second condition is set to −850 V, but an arbitrary value can be selected, so long as the absolute value of the charging voltage is equal to or greater than the discharge start voltage.

Calculation of a Correction Amount of Charging Voltage

In actual use, the output values of the discharge start voltage or the charging voltage deviates from the target value, and also the dark area potential of the photosensitive drum 4 deviates from the target value, on account of the influence of atmospheric pressure at the installation site of the image forming apparatus main body 100a, and on account of high-voltage circuit tolerances. The charging voltage must be corrected in order to correct such variations from the target value of dark area potential.

A corrected charging voltage Vₑᵣ at the time of image formation is calculated, using Expression (4) below, to calculate the correction amount of charging voltage. Herein a reference charging voltage Vₚ denotes a charging voltage value that is taken as a reference. Further, V_{DTarget} denotes an assumed surface dark area potential at the time of application of the reference charging voltage Vₚ. The CRG memory 3a and the main body memory 3b are assumed to have correction amounts stored therein.

V_{cr}=Vₚ−(charging voltage variation amount+cartridge-derived variation amount)

=Vₚ−((α−1)×Vₚ+β) Expression (4)

In Expression (4), thus, the reference charging voltage Vₚ is corrected using a denoting the variation of high-voltage power source, and β denoting the cartridge-derived variation. The dark area potential V_{D} becomes V_{DTarget}, which is a target value, as a result of application of the corrected charging voltage V_{cr} (first charging voltage) calculated in Expression (4), to the charging roller 5. As a result, the developing contrast V_{cont} and the developing back contrast V_{back} can be controlled properly, and stable image formation is made possible. The control section 101 may calculate the corrected charging voltage V_{cr} using a deviation of charging voltage (charging voltage variation amount) being a deviation deriving from the image forming apparatus main body. The control section 101 may calculate the corrected charging voltage V_{cr} using a deviation of charging voltage (charging voltage variation amount), being a deviation deriving from the image forming apparatus main body, and a deviation deriving from the process cartridge (cartridge-derived variation amount).

Charging Voltage Determination Flow

As described above, factors on account of which the dark area potential of the photosensitive drum 4 deviates from the target value include variation factors of discharge start voltage and variation factors of charging voltage. The discharge start voltage across the photosensitive drum 4 and the charging roller 5 diverges in response to changes in for instance the film thickness of the photosensitive drum 4, the environment (temperature, humidity), and atmospheric pressure. The charging voltage output diverges for instance depending on the high-voltage circuit tolerance.

The atmospheric pressure factor and the high-voltage circuit tolerance factor, which are variation factors of dark area potential, are variation amounts that remain virtually unchanged during continuous use of the image forming apparatus. Accordingly, in a case where the film thickness value of the photosensitive drum 4 of a replaced cartridge unit and the environment (temperature, humidity) at the time of the replacement are identical to the film thickness value of the photosensitive drum 4, and to the environment (temperature, humidity) at the time of execution of detection of the surface potential of the photosensitive drum 4, respectively, then the charging voltage may be corrected by the charging voltage slope α and the cartridge-derived variation amount β that are recorded in the CRG memory 3a and the main body memory 3b. Even so, it is possible to set a target-value dark area potential for replaced cartridges with dissimilar usage situations.

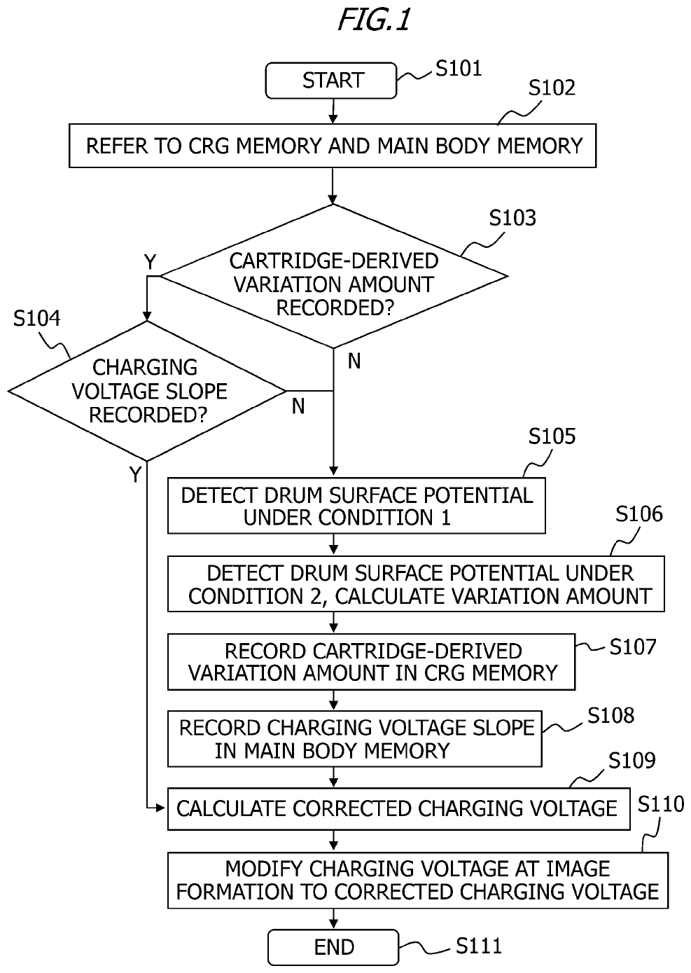

FIG. 1 is a flowchart of determination of charging voltage in Embodiment 1.

(Step S101) A charging voltage determination sequence is initiated for instance upon power-on of the image forming apparatus 100, upon attachment of the process cartridge 1 to the main body of the image forming apparatus 100, or upon reaching of a predetermined number of prints. Typically the present flow is executed in a maintenance mode of the image forming apparatus, for instance at the time of cartridge replacement, periodic inspection, or adjustment by an operator.

(Step S102) The control section 101 establishes communication with the CRG memory 3a of the process cartridge 1 via the CRG memory communication unit 109. The control section 101 also establishes communication with the main body memory 3b via the main body memory communication unit 110.

(Step S103) The control section 101 checks whether or not a cartridge-derived variation amount is recorded in the CRG memory 3a. In a case where a cartridge-derived variation amount is recorded in the CRG memory 3a (S103:Y), the process proceeds to step S104.

(Step S104) The control section 101 checks whether or not a charging voltage slope α is recorded in the main body memory 3b. In a case where the charging voltage slope α is in the main body memory 3b (S104:Y), the process proceeds to step S109.

(Step S109) In step S109 both the variation amount β which is information for correcting cartridge-side variation factors, and the charging voltage slope α which is information for correcting variation factors of the high-voltage power source side are already acquired. Therefore, the control section 101 calculates the corrected charging voltage in accordance with Expression (4), using the charging voltage slope α recorded in the main body memory 3b, and the cartridge-derived variation amount β recorded in the CRG memory 3a, without detection the surface potential of the photosensitive drum 4.

In a case by contrast where the charging voltage slope α is not recorded (S103:N), or in a case where the cartridge-derived variation amount β is not recorded (S104:N), the process proceeds to step S105.

(Step S105) The control section 101 detects the surface potential of the photosensitive drum 4 at the charging voltage (for instance −1050 V) under the first condition, and acquires V_{1(A)} as the detection result. In this case, the current detection unit 108 may detect current corresponding to the surface potential of the photosensitive drum 4, under the first condition, and transmit surface potential information, acquired from the detected current value, to the control section 101. The control section 101 may detect the surface potential of the photosensitive drum 4 on the basis of the surface potential information.

(Step S106) Next, the control section 101 detects the surface potential of the photosensitive drum 4 at the charging voltage (for instance −850 V) under the second condition, and acquires V_{1(B)} as the detection result. In this case, the current detection unit 108 may detect current corresponding to the surface potential of the photosensitive drum 4, under the second condition, and may transmit surface potential information, acquired from the detected current value, to the control section 101. The control section 101 may detect the surface potential of the photosensitive drum 4 on the basis of the surface potential information. The charging voltage slope α and the cartridge-derived variation amount β are calculated using Expression (2) and Expression (3), on the basis of V_{1(A)} and V_{1(B)}.

As in step S105 and S106, the current detection unit 108 may acquire a plurality of surface potential information items under a plurality of conditions of dissimilar charging voltage. The control section 101 may perform control so that the current detection unit 108 acquires a plurality of surface potential information items under a plurality of conditions of dissimilar charging voltage.

(Step S107) The control section 101 records the calculated cartridge-derived variation amount β in the CRG memory 3a, via the CRG memory communication unit 109.

(Step S108) The control section 101 records the charging voltage slope α in the main body memory, via the main body memory communication unit 110.

(Step S109) The control section 101 calculates the corrected charging voltage V_{cr} using Expression (4), on the basis of the charging voltage slope α and the cartridge-derived variation amount β.

(Step S110) The control section 101 modifies the charging voltage at the time of image formation to the corrected charging voltage V_{cr}.

(Step S111) This ends the charging voltage determination sequence. The image forming apparatus 100 terminates the maintenance mode and enters a stand-by state.

As explained above, in the estimation of the surface potential of the photosensitive drum 4, information corresponding to cartridge-side deviation factors (for instance variability in the surface potential of the photosensitive drum 4) and information corresponding to image forming apparatus main-body-side deviation factors (for instance deviation amount of high-voltage power source) can be calculated separately.

The cartridge-side information is stored in the CRG memory 3a. Accordingly, the information relating to the process cartridge need not be calculated again even in a case where a process cartridge is reused from one given first image forming apparatus to another second image forming apparatus.

The main-body-side information is stored in the main body memory 3b. Accordingly, information relating to the image forming apparatus main body need not be calculated again even when a given first process cartridge is replaced by another second process cartridge, in the image forming apparatus.

Thus, Embodiment 1 allows the charging voltage at the time of image formation to be corrected with good precision, and stable image formation to be accomplished, even upon replacement of a process cartridge.

The control section 101 may calculate the corrected charging voltage Vcr (first charging voltage) from the deviation of the charging voltage which is a deviation deriving from the image forming apparatus main body, calculated on the basis of the plurality of surface potential information items and the target value (V_{DTarget}) as a first value. The control section 101 may control the high-voltage power source 104 so that the corrected charging voltage Vcr is applied to the charging roller 5 during the image forming operation.

The control section 101 may calculate a deviation deriving from the process cartridge, from the plurality of surface potential information items, and a deviation deriving from the image forming apparatus main body to thereby calculate the cartridge correction information (cartridge-derived variation amount β) corresponding to a deviation deriving from the process cartridge and the main body correction information (charging voltage slope α) corresponding to a deviation deriving from the image forming apparatus main body.

Variation

In the above flow, environment information at the time of detection (for instance temperature and humidity) and environment information at the current time (image formation) are not factored in. By recording the environment information at the time of detection, in the CRG memory 3a or the main body memory 3b, however, it becomes possible to further correct the corrected charging voltage at the time of image formation, in accordance with a difference between the current environment information and the environment information at the time of detection.

For instance, it is known that also the absolute value of the surface potential of the photosensitive drum 4 tends to increase as the temperature rises, even for an identical control value of the high-voltage power source. In a case where the current temperature is higher than the temperature at the time of detection and stored in the memory, therefore, the control value of the high-voltage power source may be corrected so as to reduce the absolute value of the surface potential. In a case conversely where the current temperature is lower than the temperature at the time of detection, stored in the memory, the control value of the high-voltage power source may be corrected so as to increase the absolute value of the surface potential. As regards humidity as well, it is known that the absolute value of the surface potential of the photosensitive drum 4 tends to increase as humidity rises. Therefore, the control value may be corrected similarly to the case of the temperature. The same correction can be performed for absolute moisture content in air, which is related to temperature and humidity.

### Embodiment 2

Embodiment 2 of the present invention will be explained next. In Embodiment 2, the detection content of the surface potential in the maintenance mode is determined on the basis of the information recorded in the CRG memory 3a and the main body memory 3b, to thereby reduce detection time and to shorten downtime. A description of features of constituent elements and processes that overlap with those of Embodiment 1 will be omitted herein.

There are two detection modes (detection conditions) in Embodiment 1.

Specifically, surface potential is not detected in a case where both data of the charging voltage slope α and the charging voltage variation amount β are stored, whereas detection is performed under both a first and a second condition in a case where either one of the slope α and the variation amount β is not stored. In Embodiment 2, by contrast, there are three detection modes. Specifically, detection is not performed in a case where both the slope α and the variation amount β are stored, detection under the second condition is omitted in a case where either one is stored and the other is not, and detection under the first and the second conditions is performed in a case where neither is stored.

Calculation of the Slope of Charging Voltage and of a Cartridge-Derived Divergence Amount

Firstly, in a case where the cartridge-derived variation amount β is recorded in the CRG memory 3a but the charging voltage slope α is not recorded in the main body memory 3b, the control section 101 calculates the charging voltage slope α using Expression (5) below, on the basis of the cartridge-derived variation amount β recorded in the CRG memory 3a. Therefore, it suffices to calculate just V_{1(A)} by performing a one-time measurement under the first condition, while a measurement under the second condition is not necessary.

α=1±(V_{1(A)}−β−(V_{DTarget}))/Vₚᵣₑ Expression (5)

In a case where the charging voltage slope α is recorded in the main body memory 3b but the cartridge-derived variation amount β is not recorded in the CRG memory 3a, the cartridge-derived variation amount β is calculated using Expression (3) above, on the basis of the charging voltage slope α recorded in the main body memory 3b. Therefore, it suffices to calculate just V_{1(A)} by performing a measurement under the first condition, while a measurement under the second condition is not necessary.

In Embodiment 2, thus, the steps of measurement under the second condition and of calculation of the surface potential can be omitted, by using Expression (5) or Expression (3). The time of the maintenance mode can be shortened as a result.

(Charging Voltage Determination Flow in Embodiment 2)

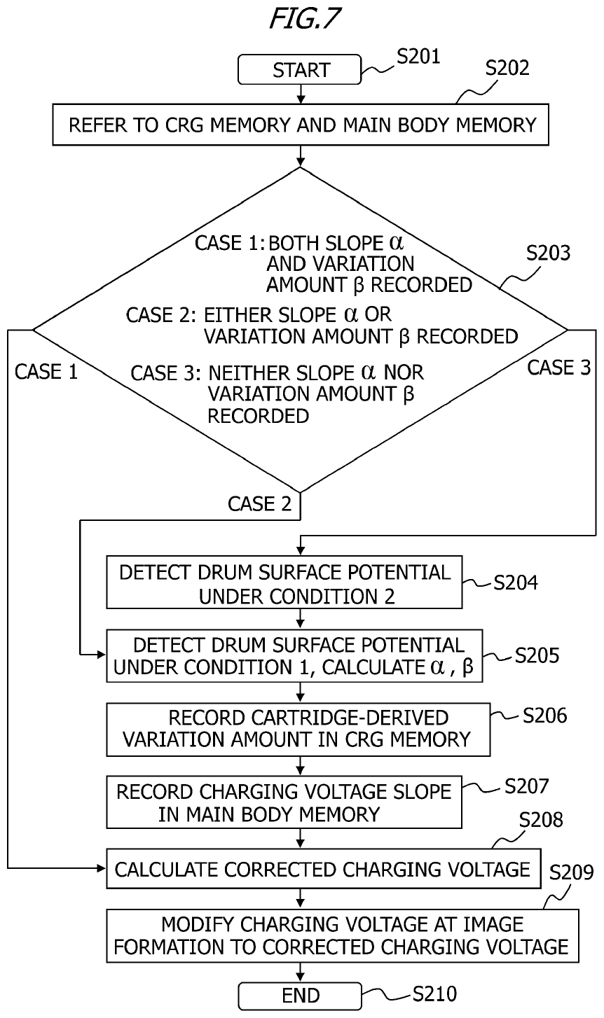

FIG. 7 is a flowchart of determination of charging voltage in Embodiment 2. The operation of each structure will be described in detail. A detailed explanation of steps identical to those of FIG. 1 of Embodiment 1 will be omitted herein. The detection mode in Embodiment 2 is set out in Table 1. In the present flow, any one of three detection modes, namely “no detection”, “detection only under a first condition”, and “detection under a first and a second condition”, is selected on the basis of the presence or absence of recording; yet finer control can be performed therefore as compared with Embodiment 1, which translates into a shorter downtime.

TABLE 1

| | | Divergence amount β recorded | |
|---|---|---|---|
| | | Yes | No |
| Slope α | Yes | Detection under | Detection under |
| recorded | | Condition 1 or | Condition 2 not necessary; |
| | | Condition 2 not | calculate β from |
| | | necessary | Expression (3) |
| | No | Detection under | Detection under |
| | | Condition 2 not necessary; | Condition 1 and |
| | | calculate α from | Condition 2 necessary |
| | | Expression (5) | |

(Step S201) A maintenance mode is entered in, and the flow is initiated, for instance upon power-on of the image forming apparatus 100, or upon replace of a process cartridge, or upon reaching of a predetermined number of prints.

(Step S202) The control section 101 establishes communication with the CRG memory 3a and the main body memory 3b.

(Step S203) The control section 101 checks whether the charging voltage slope α is recorded or not, by referring to the main body memory 3b, and checks whether the cartridge-derived variation amount β is recorded or not, by referring to the CRG memory 3a. The control section 101 determines a detection mode (detection condition) on the basis of the presence or absence of recording. In Case 1 below, the process proceeds to step S208, in Case 2 the process proceeds to step S205 and in Case 3 the process proceeds to step S204.

Case 1: both the slope α and the variation amount β are stored;

Case 2: either the slope α or the variation amount β is stored; and

Case 3: neither the slope α nor the variation amount β is stored.

(Step S204) In a case where neither the slope α nor the variation amount β is recorded, the control section 101 executes measurement under the second condition, and calculates V_{1(B)} as the detection result.

(Step S205) The control section 101 executes measurement under the first condition, and calculates V_{1(A)} as the detection result. The control section 101 calculates the slope α and the variation amount β on the basis of Expression (2) and Expression (3).

(Step S206) The control section 101 records the variation amount β in the CRG memory 3a.

(Step S207) The control section 101 records the charging voltage slope α in the main body memory 3b.

(Step S208) The slope α and the variation amount β have been already acquired by this step, regardless of the determination result in step S203. Therefore, the control section 101 calculates the corrected charging voltage V_{cr} using Expression (4).

(Step S209) The control section 101 modifies the charging voltage at the time of image formation to the corrected charging voltage Vcr.

(Step S210) This ends the charging voltage determination sequence.

As explained above, in Embodiment 2 charging voltage is corrected by referring to the CRG memory 3a and the main body memory 3b, similarly to Embodiment 1, and hence stable image forming is made possible. In Embodiment 2, moreover, the surface potential of the photosensitive drum 4 is detected only to the extent necessary, and hence downtime is shortened.

Correction based on environment information including temperature and humidity, such as that described in Embodiment 1, can be preferably applied to Embodiment 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2019-166195, filed on Sep. 12, 2019, which is hereby incorporated by reference herein in its entirety.

What is claimed is:

1. An image forming apparatus, comprising:
an apparatus main body; and
a process cartridge that is replaceable relative to the apparatus main body,
the process cartridge having:
an image bearing member; and
a charging member that forms, by being applied with charging voltage, a surface potential by charging a surface of the image bearing member,
the apparatus main body having:
a power supply portion that applies the charging voltage to the charging member;
a potential detection portion that detects surface potential information relating to the surface potential formed on the surface of the image bearing member; and
a control portion that calculates a first charging voltage, at which the surface potential has a first value, on the basis of the surface potential information, and that controls the power supply portion and the potential detection portion,
wherein the potential detection portion acquires a plurality of the surface potential information items under a plurality of conditions where the charging voltage differs, and
wherein the control portion calculates the first charging voltage from a deviation of the charging voltage, which is a deviation deriving from the apparatus main body and calculated on the basis of the plurality of the surface potential information items and the first value, and controls the power supply portion so that the first charging voltage is applied to the charging member during an image forming operation.

2. The image forming apparatus according to claim 1,
wherein the control portion calculates, from the plurality of the surface potential information items and the deviation deriving from the apparatus main body, a deviation deriving from the process cartridge,
thereby calculating cartridge correction information corresponding to the deviation deriving from the process cartridge, and main body correction information corresponding to the deviation deriving from the apparatus main body, and
calculating the first charging voltage on the basis of the cartridge correction information and the main body correction information.

3. The image forming apparatus according to claim 2, wherein
the process cartridge has a cartridge memory,
the apparatus main body has a main body memory, and
wherein the control portion performs control so that the cartridge correction information is stored in the cartridge memory and the main body correction information is stored in the main body memory.

4. The image forming apparatus according to claim 3,
wherein, when calculating the first charging voltage, the control portion determines a detection condition for a time at which the potential detection portion acquires the surface potential information, on the basis of whether the cartridge correction information is stored in the cartridge memory and on the basis of whether the main body correction information is stored in the main body memory.

5. The image forming apparatus according to claim 4,
wherein in a case where the cartridge correction information is stored in the cartridge memory and the main body correction information is stored in the main body memory, the control portion performs control so that the first charging voltage is calculated using the cartridge correction information stored in the cartridge memory and the main body correction information stored in the main body memory, without acquiring the surface potential information by the potential detection portion.

6. The image forming apparatus according to claim 4,
wherein in a case where the cartridge correction information is not stored in the cartridge memory and the main body correction information is not stored in the main body memory, the control portion performs control so that the plurality of the surface potential information items under a plurality of conditions where the charging voltage differs are acquired by the potential detection portion.

7. The image forming apparatus of claim 4,
wherein the control portion
in a case where the cartridge correction information is stored in the cartridge memory and the main body correction information is not stored in the main body memory, or in a case where the cartridge correction information is not stored in the cartridge memory and the main body correction information is stored in the main body memory,
performs control so that one surface potential information item is acquired by the potential detection portion, and
calculates either the cartridge correction information or the main body correction information not stored in either the cartridge memory or the main body memory on the basis of the one surface potential information item, and either the cartridge correction information or the main body correction information stored in either the cartridge memory or the main body memory.

8. The image forming apparatus according to claim 3,
wherein the control portion performs control of calculating information relating to a change in the charging voltage on the basis of a plurality of the charging voltages for acquiring the plurality of the surface potential information items and the plurality of the surface potential information items, thereby rendering the information relating to the change thus calculated to serve as the main body correction information.

9. The image forming apparatus according to claim 8,
wherein the control portion performs control so as to acquire the cartridge correction information on the basis of the first value, the deviation of the charging voltage, and the information relating to the change.

10. The image forming apparatus according to claim 1, further comprising a transfer portion disposed opposite the image bearing member, and transferring a toner image formed on the surface of the image bearing member to a recording material, by being applied with transfer voltage from the power supply portion,
wherein the potential detection portion detects a value of a transfer current flowing in the transfer portion, and acquires the surface potential information on the basis of a value of the transfer voltage and a value of the transfer current.

11. The image forming apparatus according to claim 10,
wherein the control portion performs control so as to detect for a plurality of times the value of the transfer current while modifying by the potential detection portion the value of the transfer voltage, thereby acquiring a plurality of discharge start voltages at which discharge starts between the charging member and the image bearing member, and acquiring the surface potential information on the basis of a plurality of the discharge start voltages.

12. The image forming apparatus according to claim 3, further comprising an environment information acquisition portion that acquires environment information including at least one of temperature and humidity,
wherein the environment information acquisition portion stores the acquired environment information in the cartridge memory, and
wherein the control portion performs control of calculating the first charging voltage on the basis of the environment information at a time of acquisition of the surface potential information, and the environment information at the current time.

13. The image forming apparatus according to claim 1,
wherein the control unit performs control of calculating the first charging voltage in a maintenance mode at a time of replacement of the process cartridge relative to the apparatus main body.
